(19) United States
(12) Patent Application Publication
(10) Pub. No.: US 2017/0225755 A1
(43) Pub. Date: Aug. 10, 2017

(54) Weapons Control System-Deployable Life Support Apparatus

(71) Applicant: Lockheed Martin Corporation, Bethesda, MD (US)

(72) Inventors: Ronald L. Wilson, Fort Worth, TX (US); Douglas S. Abernathy, White Settlement, TX (US); Glenn Charles Salisbury, III, Fort Worth, TX (US)

(21) Appl. No.: 15/015,599

(22) Filed: Feb. 4, 2016

(51) Int. Cl. B63C 9/23; B64D 25/16; B63C 9/04; B64D 25/12; F41A 19/58; B63C 9/03

(52) U.S. Cl. CPC B63C 9/23; F41A 19/58; B63C 9/03; B63C 9/04; B64D 25/12; B64D 25/16; B63C 2009/042; B63C 2009/044

(57) ABSTRACT

According to one embodiment, an apparatus includes an outer shell having a shape substantially similar to a weapon. The outer shell is configured to be coupled to an aircraft at a weapon attachment point. The apparatus further includes one or more electrical connections configured to be coupled to a weapons control system of the aircraft. The apparatus further includes a life support package comprising an inflatable raft and a stabilization system configured to stabilize the inflatable raft in water.

### TECHNICAL FIELD

This disclosure relates in general to life support systems and more particularly to a life support system that is deployable using a weapons control system of an aircraft.

### BACKGROUND

Historically dual engine aircraft have been considered the best way to assure safe operations when flying over harsh environments because dual engine failures are exceptionally rare. However, this approach is inherently expensive, restricts aircraft performance, and limits the choices of aircraft purchased by some national governments.

### SUMMARY OF THE DISCLOSURE

According to one embodiment, an apparatus includes an outer shell having a shape substantially similar to a weapon. The outer shell is configured to be coupled to an aircraft at a weapon attachment point. The apparatus further includes one or more electrical connections configured to be coupled to a weapons control system of the aircraft. The apparatus further includes a life support package comprising an inflatable raft and a stabilization system configured to stabilize the inflatable raft in water.

Technical advantages of certain embodiments may include a cheaper, more flexible safety option to dual engine aircraft, may provide a life support package that can be tailored to the expected environment, and allows the ability to carry or not carry safety equipment depending on the mission. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an assembled view of a weapons control system-deployable life support apparatus, according to certain embodiments;

FIG. 2 illustrates a top down view of an example life support apparatus immediately prior to landing, according to certain embodiments; and

FIGS. 3A-3C illustrate an example inflatable raft comprising a stabilization system, according to certain embodiments.

### DETAILED DESCRIPTION OF THE DISCLOSURE

Because dual engine failures are exceptionally rare, dual engine aircraft have been considered the best way to assure safe operations when flying over harsh environments. Although single engine aircraft have a number of practical advantages (e.g., decreased fuel usage, longer flight times) some potential customers have expressed safety concerns for the use of a single engine aircraft over geographically remote areas or areas with extreme environmental conditions (e.g. arctic, desert, cold water) because any mechanical failure resulting in a pilot ejection would put the pilot in jeopardy due to the harshness of the environment. For example, a downed pilot in cold water may not be able to wait for backup aid from another aircraft or boat, as the pilot may have only a matter of minutes to find dry conditions (e.g., a raft) before succumbing to hypothermia. Aircraft, especially single engine aircraft, may be ill equipped to provide aid to their downed pilots in the short amounts of time necessary to ensure survival of the pilots in these environments.

Accordingly, aspects of the present disclosure provide a life support apparatus that can be loaded onto a weapon attachment point of an aircraft (e.g., the location at which a bomb or missile would typically be loaded onto) and deployed using the weapons control system of the aircraft (e.g., the control system of the aircraft that enables the pilot to deploy the weapons loaded onto the aircraft). Life support apparatuses according to the present disclosure may thus allow for increased flexibility in deployment, as the apparatus can be carried by any number of aircraft on a particular mission as appropriate to the circumstances. For instance, a life support apparatus according to the present disclosure may include an outer shell that is formed similar to a bomb or missile that is typically carried by an aircraft, with the outer shell carrying one or more life support components (e.g., an inflatable raft) therein. The life support apparatus may be deployed from the aircraft using the aircraft's own weapons control system, avoiding the need for expensive deployment systems to be developed and fit to the aircraft. Thus, aspects of the present disclosure provide a cost effective way of fitting already-deployed aircraft with life support apparatuses, enhancing survivability for pilots or other individuals who must fly over harsh environments and alleviating at least some of the safety concerns surrounding single engine aircraft.

Embodiments of the present disclosure may provide numerous benefits. For example, a life support apparatus according to the present disclosure may provide increased survival rates for downed pilots at a substantially decreased cost. The survival probability for downed pilots (especially of single engine aircraft) may be increased, for example, by many orders of magnitude over current solutions. In addition, development costs (e.g., cost to develop the solution), integration costs (e.g., costs to integrate the solution), and life cycle costs (e.g., costs to sustain the solution after integration) are all decreased by embodiments of the present disclosure due to the usage of existing aircraft technology, such as the weapons storage and control systems, for storage and deployment.

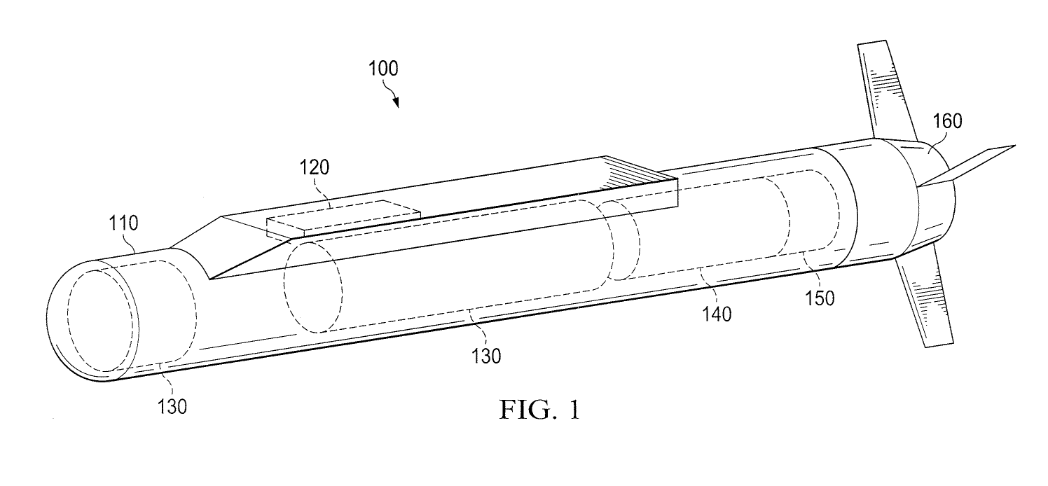

To facilitate a better understanding of the present disclosure, the following examples of certain embodiments are given. In no way should the following examples be read to limit, or define, the scope of the disclosure. Embodiments of the present disclosure and its advantages may be best understood by referring to FIGS. 1-3, where like numbers are used to indicate like and corresponding parts

FIG. 1 illustrates an assembled view of a weapon system-deployable life support apparatus 100, according to certain embodiments. Apparatus 100 includes outer shell 110, electrical connections 120, and one or more life support packages 130. In some embodiments, apparatus 100 may include a guidance system 140. Although different embodiments of apparatus 100 may have different sizes, shapes, and weights depending on the system needs (e.g., cold water protection, desert protection) and the type of carrying aircraft (e.g., F-16, F-35)), apparatus 100 will generally be the size, weight, and shape of a bomb, missile, or other weapon approved to be carried by carrying aircraft so that the separation effects of apparatus 100 will be similar to the approved weapon.

In particular embodiments, the mass characteristics of apparatus 100 may be substantially similar to those of the weapon that apparatus 100 is replacing on the carrying aircraft. For instance, ballast weights (not shown) may be included in or coupled to portions of apparatus 100 to match the weight and moments of inertia of the weapon that apparatus is replacing on the carrying aircraft. In certain embodiments, the ballast weights may be used to carry certain survival supplies, such as drinking water.

Apparatus 100 may be loaded onto a carrying aircraft at a typical weapons attachment point. For example, apparatus 100 may be loaded onto the aircraft at a typical attachment point for a bomb or missile that would be carried by the aircraft. Apparatus 100 may be loaded and carried on an aircraft with other weapon stores, in some embodiments, and may be deployed similar to air-to-surface weapons after an event that results in downed crew members or other stranded individuals. Apparatus 100 may be deployed to a target that is at a minimum safe distance from a stranded individual, and may provide life support supplies via life support package 130 that may increase the stranded individual's survivability in harsh environments. In some embodiments, apparatus 100 may be buoyant to provide life support supplies to stranded individuals in water environments (e.g., oceans, seas, or lakes). Furthermore, apparatus 100 may be deployed to aid in other situations where immediate land- or water-based rescue is not possible, such as to aid stranded civilians with survival until such rescue is possible. In certain embodiments, apparatus 100 may be deployed by the weapons control system of the aircraft after a specific flight event, such as the detection of rapid descent or the detection of critical engine damage.

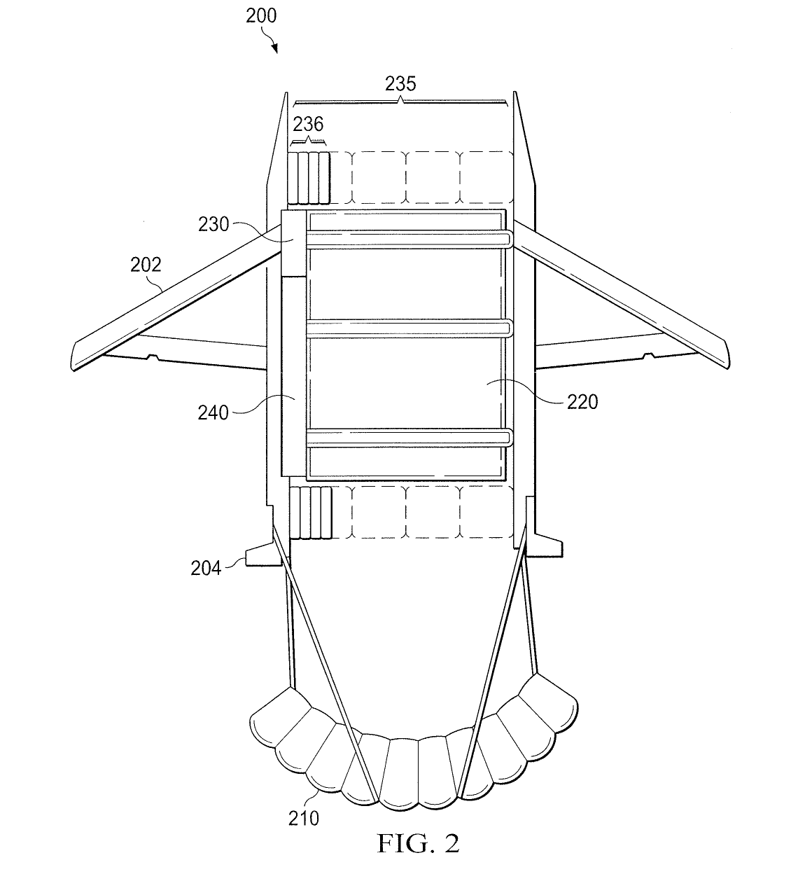

Outer shell 110 may be any shell, casing, container, husk, or vessel that is capable of holding life support package 130 and operable to be loaded on and deployed by the weapons system of the carrying aircraft. In some embodiments, outer shell 110 may be the weapon shell of an existing missile or bomb with portions such as the warhead and seeker removed. For example, and as illustrated in FIG. 1, outer shell 110 maybe the weapons shell of a small diameter bomb (e.g., SDB-II). As another example, and as shown in FIG. 2, outer shell 110 maybe the weapons shell of a larger bomb such as a bomb compatible with a Joint Direct Attack Munition (JDAM) guidance kit. Although expensive, use of an existing warhead shell for a weapon that has already been approved for the carrying aircraft may be advantageous because apparatus 100 would likely behave similar to the approved weapon (e.g., similar separation effects) and may not require recertification for use on the aircraft. In some embodiments, outer shell 100 may be a container shaped aerodynamically similar to an existing weapons shell. For example, outer shell 100 may have a length, wingspan, tail fin, external mold lines, and general body shape of an existing weapon. In some embodiments, outer shell 100 may be made of the same materials as the shell of a missile, bomb, or other weapon carried by the aircraft; however, it need not be. For example, outer shell 100 may be made of a lighter weight material such as fiberglass. Use of lighter materials may be advantageous as it may allow a heavier life support package 130 without increasing the overall weight of apparatus 100.

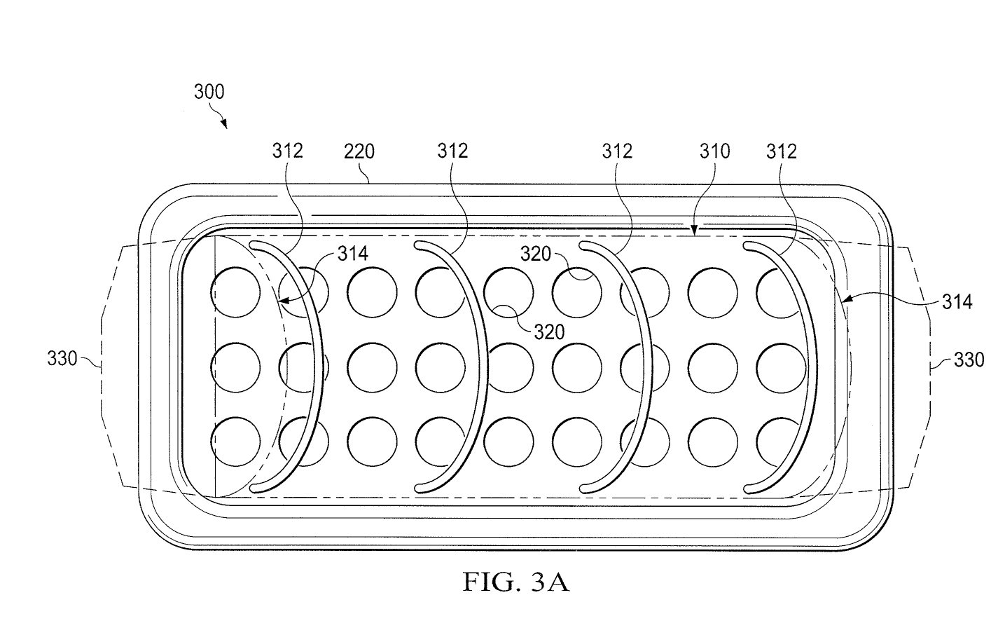

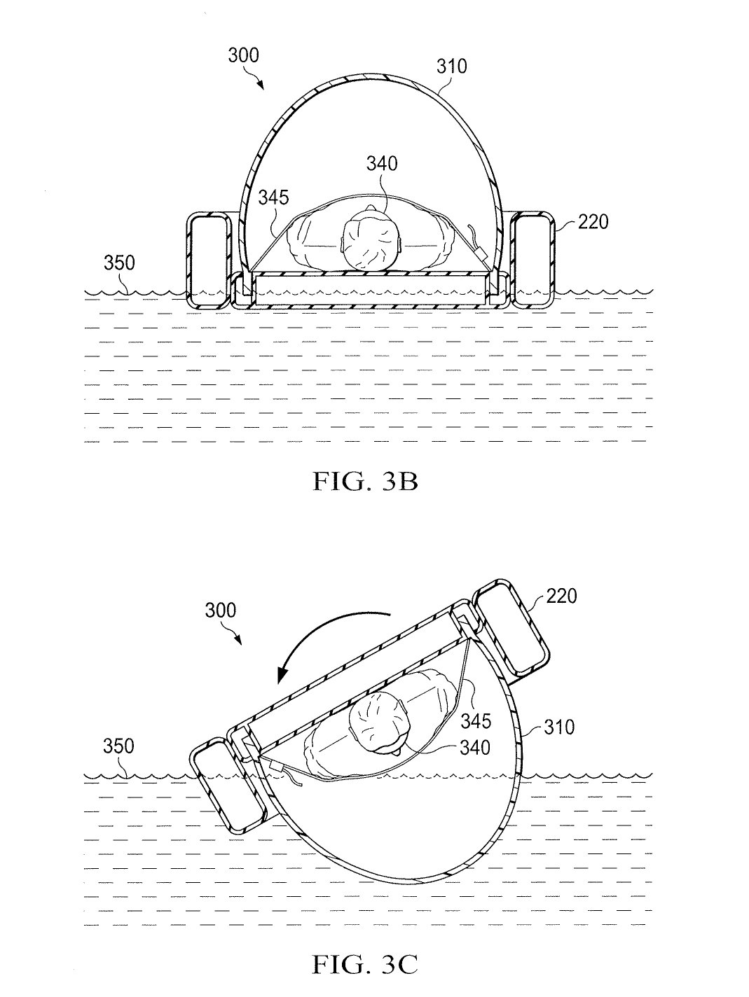

Electrical connections 120 includes any suitable electrical control system that is configured to communicatively couple to the weapons deployment system of the carrying aircraft to apparatus 100. Electrical connections 120 may accordingly allow for apparatus 100 to be deployed in a manner similar to any other weapon carried by the aircraft. In some embodiments, electrical connections 120 may be identical to the electronic system used by a weapon (e.g., a bomb or missile). In other embodiments, electrical connections 120 may be modeled after the deployment circuity of a weapon, but may not contain all of the circuitry or may include additional circuitry. For example electrical connections 120 may not include a weapon's detonation or seeker circuitry. As another example, electrical connections 120 may include circuitry that is configured to inflate a raft included in life support package 130 prior to landing (or shortly thereafter) and/or to deploy a drag parachute coupled to apparatus 100 (as discussed below with reference to FIGS. 2 and 3).

Life support package 130 fits within outer shell 110 and includes any suitable survival gear that may be contained within apparatus 100. Life support package 130 may provide one or more individuals with survival gear that may provide a warm, dry, safe environment and/or extend the expected survival time of such individuals prior to rescue. For example, life support package 130 may contain different individual components depending on the anticipated environment (e.g., cold water, desert, artic, jungle) over which an aircraft will be deployed. In certain embodiments, life support package 130 may contain one or more of the following items: a heated sleeping bag, a flotation device, electrical power (e.g., batteries), communications equipment, food, water, a medical kit, oxygen or other compressed gas, light sources (e.g., flashlights), heat sources (e.g., matches or other fire starting apparatuses), or shelter (e.g., a tent). In some embodiments, life support package 130 may include a beacon or other signal generator to alert the stranded individual to the location of apparatus 100, to alert rescue or other personnel that apparatus 100 has been deployed, and/or to alert rescue or other personnel of the approximate location of apparatus 100 after deployment. In certain embodiments, life support package 130 may contain an inflatable raft and a stabilization system described in more detail in FIGS. 2 and 3 below.

In some embodiments, apparatus 100 may include a guidance system 140. Guidance system 140 may include any suitable system that can control, steer, or influence the direction of apparatus 100 after it has been deployed from the carrying aircraft. In some embodiments, guidance system 140 may include extendable wings (e.g., wings 202 of FIG. 2), a tail section with aerodynamic control surfaces (e.g., tail section 160 of FIG. 1 or tail section 204 of FIG. 2), a Inertial Guidance System (INS), a Global Positioning System (GPS) receiver, or any suitable combination thereof. In some embodiments, guidance system 140 may be identical to the system used with the weapon typically mounted on the aircraft (i.e., the weapon that apparatus 100 has replaced on the aircraft). In other embodiments, guidance system 140 may be modeled after the guidance system of a weapon, but may not contain all of the circuitry. For example, guidance system 140 may not include seeker or other circuitry indented to follow a particular target. In some embodiments, guidance system 140 may be a “bolt-on” guidance kit used to convert bombs that have no internal guidance system (i.e., unguided or gravity bombs) into Precision-Guided Munitions (PGMs). For example, guidance system 140 may be a Joint Direct Attack Munition (JDAM) guidance kit. In particular embodiments, apparatus 100 may be intended for a low altitude release. In such embodiments, apparatus 100 may not include a guidance system 140 and may be deployed like an unguided bomb. In some embodiments, apparatus 100 may include a water propulsion device 150 that allows apparatus 100 to be maneuvered by or directed toward the stranded individual in the water environment. The water propulsion device 150 may include any suitable water propulsion system, such as a pump-jet or hydrojet using an impeller to create thrust. In certain embodiments, the water propulsion device 150 may be controlled using a remote control. For example, a stranded individual may use a remote control to direct (i.e., propel and steer) apparatus 100 towards themselves to avoid expending their own energy in swimming to apparatus 100.

Modifications, omissions, or additions may be made to FIG. 1 without departing from the scope of the present disclosure. For example, apparatus 100 may contain additional or fewer components than those illustrated. As another example, the relative locations of components contained within outer shell 110 of apparatus 100 (e.g., life support package 130 and guidance system 140) may be different than those illustrated. As yet another example, the size and/or shape of outer shell 110 of apparatus 100 may be different than that illustrated. As yet another example, apparatus 100 may include additional aerodynamic control surfaces beyond tail section 160 (e.g., wings similar to apparatus 200 of FIG. 2).

FIG. 2 illustrates a top down view of an example life support apparatus 200 immediately prior to landing, according to certain embodiments. Apparatus 200 is a particular embodiment of apparatus 100 of FIG. 1 described above. Apparatus 200 includes parachute 210, inflatable raft 220, inflation system 230, and sealed storage bay 240. Apparatus 200 may also include other suitable life support devices incorporated therein, such as those described above with reference to apparatus 100. As illustrated, in some embodiments, apparatus 200 may expand after deployment to a configuration similar to that shown in FIG. 2 to allow access to the components therein. For instance, apparatus 200 may split into two sections after being deployed from the aircraft (e.g., split in half as illustrated in FIG. 2) to expose inflatable raft 220 or other components in storage bay 240 to a stranded individual. In some embodiments, apparatus 200 may include extendable wings 202 and a tail section 204 with aerodynamic control surfaces. Wings 202 and tail section 204 may be controlled using a guidance system of apparatus 200 (e.g., guidance system 140 of FIG. 1 described above).

Parachute 210 is deployed sometime during the descent of apparatus 200 (i.e., between the time apparatus 200 has been deployed from the aircraft and prior to landing). Parachute 210 may be sized according to the size, shape, and/or weight of apparatus 200 and may serve different functions in different embodiments, which may depend on particular system needs. For example, if a water landing is anticipated, parachute 210 may be attached to one end of apparatus 200 (e.g., as a tail chute or drag chute) and may reduce the airspeed of apparatus 200. In some embodiments, parachute 210 may be a parafoil style parachute, which may increase the buoyancy of apparatus 200 or allow parachute 210 to be used as a flotation device after apparatus 200 has landed. In some embodiments, parachute 210 may minimize air drift to during the descent of apparatus 200. This may be particularly advantageous when apparatus 200 is not equipped with a guidance system such as guidance system 140 of FIG. 1. In some embodiments, apparatus 200 may include one or more parachutes 210. For example, apparatus 200 may include a first parachute configured as a tail chute and a second parachute configured as a nose chute. Such a configuration may be used for a soft landing over certain terrains.

Inflatable raft 220, inflation system 230, and sealed storage bay 240 are components that may be included in life support package 130 described above with reference to apparatus 100. Inflatable raft 220 may be any suitable raft, flotation device, or buoyant structure. In some embodiments, inflatable raft 220 may be attached to a stabilization system such as stabilization system 300 described further below with reference to FIGS. 3A-3C. In some embodiments, inflatable raft 220 may be insulating to protect the individual from adverse weather conditions or water temperature. In other embodiments, inflatable raft 220 may not be insulating and thermal protection may be provided by other components of life support package 130 (e.g., one or more blankets or items of clothing provided therein). In some embodiments, inflatable raft may have a mesh floor (e.g., made of SPANDEX or other suitable mesh material) that allows for the easy ingress from the water or may have drainage holes for water drainage as shown in FIG. 3A.

In some embodiments, inflatable raft 220 may use compressed gas to increase its size after it has been deployed; however, it need not. For example, inflatable raft 220 may be compressed under pressure (e.g., vacuum packed and sealed inside apparatus 200) and allowed to naturally expand after deployment. In some embodiments, inflatable raft 220 may inflate based on a signal from an electronic control system (e.g., electrical connections 120 of FIG. 1) or a guidance system (e.g., guidance system 140 of FIG. 1) of apparatus 200. However, in other embodiments, inflation may require action by a stranded individual. For example, the stranded individual may be required to use a pump, connect a gas source or press a button to start inflation. In some embodiments, inflatable raft 220 may be automatically inflated by an inflation system, such as inflation system 230 described below. In some embodiments, inflatable raft 220 may be configured to partially or fully inflate prior to landing. This may be advantageous when a cold water landing is expected for apparatus 200, as it will decrease the time that the stranded individual is in the cold water. In some embodiments, the inflatable raft 220 may be inflated prior to landing in order to decrease the airspeed of apparatus 200 during landing.

In some embodiments, inflatable raft 220 may deploy between two sections of the outer shell of apparatus 200, as shown in FIG. 2. In other embodiments, inflatable raft 220 may deploy from a side of apparatus 200. In such embodiments, inflatable raft 220 may be tied to apparatus 200 by one or more tether lines.

In some embodiments, inflatable raft 220 may have a plurality of inflation states to provide easy access thereto by an occupant. For example, inflatable raft 220 may have two states of inflation: one partial or intermediate inflation state that may allow the occupant easier access to inflatable raft 220 from water (e.g., allowing inflatable raft 220 to be partially submerged during ingress), and a full inflation state that is more appropriate for long term survival. Additional inflation states may also be used for other purposes. Such intermediate or partial inflation states may allow for easier ingress or egress from inflatable raft 220 by a downed pilot.

Inflation system 230 includes any suitable mechanism for inflating inflatable raft 220 or other components of apparatus 200 such as expansion system 235. Expansion system may include inflatable bags 236, in some embodiments. In some embodiments, inflation system 230 may be configured to inflate one or more portions (e.g., bags 236) of expansion system 235 during the decent of apparatus 200, causing apparatus to split into sections as illustrated in FIG. 2. The inflatable portions (e.g., bags 236) of expansion system 235 may be compressed similar to inflatable raft 220 while mounted to aircraft, and may expand after deployment of apparatus 200 in order to split apparatus 200 into two or more sections as illustrated.

Storage bay 240 is a storage space that allows storage of components of life support package 130 so they are not misplaced when inflatable raft 220 is inflated and/or apparatus 200 is split into two or more sections as illustrated in FIG. 2. In some embodiments, a sealed storage compartment may be included in the interior of the outer shell of apparatus 200. In some embodiments, storage bay 240 may be sealed to prevent the components from getting wet. In some embodiments, storage bay 240 may be accessible from the exterior of apparatus 200. This may be advantageous when it is necessary to replace or test components of apparatus 200, as this can be done without disturbing other components of apparatus 200. For example, batteries and/or food could be stored in storage bay 240. In this example embodiment, battery life could be tested or food packages could be replaced without triggering the inflatable raft 220 to inflate.

Modifications, omissions, or additions may be made to FIG. 2 without departing from the scope of the present disclosure. For example, apparatus 200 may contain additional or fewer components than those illustrated. As another example, the relative locations of components contained within apparatus 200 may be different than those illustrated. As yet another example, the size and/or shape of apparatus 200 may be different than that illustrated. As yet another example, although illustrated as being split into two sections, apparatus 200 may be split into any suitable number of sections during decent.

FIGS. 3A-3C illustrate an example inflatable raft 220 comprising a stabilization system 300, according to certain embodiments. Inflatable raft 220 may be any suitable type of inflatable life support device for use with a life support apparatus similar to apparatuses 100 and 200 of FIGS. 1 and 2, respectively. Thus, the size, shape, and/or weight of inflatable raft 220 may depend on the intended deployment of the aircraft carrying the life support apparatus within which inflatable raft 200 is contained.

Stabilization system 300 may include any suitable components configured to stabilize a stranded individual (e.g., occupant 340 in FIGS. 3B-3C) using a life support apparatus according to the present disclosure. For example, as illustrated, stabilization system 300 includes dome 310, dome cover flaps 330, and restraining system 345. In some embodiments, dome 310 and dome cover flaps 330 are attached to inflatable raft 220. In such embodiments, the floor of inflatable raft 220, dome cover flaps 330, and dome 310 may provide an cavity that is water tight and allows inflatable raft 220 to right itself if capsized in water 350 as illustrated in FIGS. 3B-3C. Although illustrated as being coupled to inflatable raft 220, in some embodiments, the life support package holding inflatable raft 220 may include dome 310 as a stand-alone shelter uncoupled from inflatable raft 220. Restraining system 345 may be any suitable system for restraining occupant 340 of stabilization system 300, such as one or more restraining belts. As illustrated, inflatable raft may comprise one or more drainage holes 320 for water drainage after deployment, to keep an occupant of stabilization system 300 dry.

Dome 310 includes flex rods 312 and dome cover 314. In some embodiments, dome 310 forms a cavity configured to contain occupant 340 and may provide shade, cover, insulation, or other benefits that separate occupant 340 from the surrounding environment. In some embodiments, one or more flex rods 312 provide structure to dome 310. Although illustrated as traversing from one side of inflatable raft 220 to the other, flex rods 312 may originate and terminate in any direction and may not necessarily be attached to inflatable raft 220. Flex rods 312 may be made of any suitable material. For example, limitation flex rods 312 may be made of fiberglass or metal. In some embodiments, flex rods 312 may lay flat until stabilization system 300 is deployed and inflatable raft 220 is inflated.

Dome cover 314 may be a lightweight cover that fits over flex rods 312 to form dome 310 of stabilization system 300. Depending on the anticipated environment over which an aircraft holding inflatable raft 220 and stabilization system 300 may be deployed, dome cover 314 may be made of light plastic, canvas, synthetic material, or an insulating polymer (e.g., aerogel). In some embodiments, dome 310 includes dome cover flaps 330. Dome cover flaps 330 may provide access into and out of dome 310, and may be made of the same material as dome cover 314. Alternatively, dome cover flaps 330 may be made of a different or thicker material than that of dome cover 314.

In certain embodiments, flex rods 312 may be non-rigid and may be inflated pressurized air from inflation system 230. For example, pressurized air from inflation system 230 may be used to inflate flex rods 312 in such a way that causes flex rods 312 to expand and erect to create the cavity within which occupant 340 resides.

Modifications, omissions, or additions may be made to FIGS. 3A-3C without departing from the scope of the present disclosure. For example, although illustrated as comprising certain components, stabilization system 300 may comprise fewer or additional components. As another example, although illustrated as being capable of holding and stabilizing a single occupant 345, stabilization system 300 may be capable of holding and stabilizing additional occupants 345.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A apparatus, comprising:
an outer shell having a shape substantially similar to a weapon, the outer shell configured to be coupled to an aircraft at a weapon attachment point;
one or more electrical connections configured to be coupled to a weapons control system of the aircraft; and
a life support package comprising:
an inflatable raft; and
a stabilization system configured to stabilize the inflatable raft in water.

2. The apparatus of claim 1, further comprising a source of compressed gas for inflating the inflatable raft.

3. The apparatus of claim 1, further comprising an inflation system configured to automatically inflate the inflatable raft after deployment from the aircraft.

4. The apparatus of claim 1, further comprising one or more parachutes.

5. The apparatus of claim 1, further comprising a guidance system configured to direct the apparatus after deployment from the aircraft.

6. The apparatus of claim 1, further comprising a beacon configured to provide a location signal.

7. The apparatus of claim 1, wherein the stabilization system comprises:
a dome coupled to the inflatable raft, the dome configured to prevent permanent capsizing of the inflatable raft; and
dome cover flaps configured to create a barrier between the interior of the dome and an outside environment.

8. The apparatus of claim 1, further comprising a battery configured to provide electrical power to one or more components of the life support package.

9. The apparatus of claim 1, further comprising a water propulsion system.

10. An system, comprising:
an aircraft comprising one or more weapon attachment points and a weapons control system; and
a life support apparatus coupled to the aircraft at a weapon attachment point, the life support apparatus comprising:
one or more electrical connections communicably coupled to the weapons control system of the aircraft; and
a life support package comprising:
an inflatable raft; and
a stabilization system configured to stabilize the inflatable raft in water; and
wherein the life support apparatus is configured to be deployed from the aircraft using the weapons control system of the aircraft.

11. The system of claim 10, wherein the weapons control system if configured to deploy the life support apparatus automatically after a specific flight event.

12. The system of claim 10, wherein the life support apparatus further comprises a source of compressed gas for inflating the inflatable raft.

13. The system of claim 10, wherein the life support apparatus further comprises an inflation system configured to automatically inflate the inflatable raft after deployment from the aircraft.

14. The system of claim 10, wherein the life support apparatus further comprises one or more parachutes.

15. The system of claim 10, wherein the life support apparatus further comprises a guidance system configured to direct the apparatus after deployment from the aircraft.

16. The system of claim 10, the life support apparatus further comprises a beacon configured to provide a location signal.

17. The system of claim 10, wherein the stabilization system comprises:
a dome coupled to the inflatable raft, the dome configured to prevent permanent capsizing of the inflatable raft; and
dome cover flaps configured to create a barrier between the interior of the dome and an outside environment.

18. The system of claim 10, wherein the life support apparatus further comprises a battery configured to provide electrical power to one or more components of the life support package.

19. The system of claim 10, wherein the life support apparatus further comprises a water propulsion system.

20. A apparatus, comprising:
an outer shell having a shape substantially similar to a weapon, the outer shell configured to be coupled to an aircraft at a weapon attachment point;
one or more electrical connections configured to be coupled to a weapons control system of the aircraft; and
a life support package comprising:
an inflatable raft;
a stabilization system configured to stabilize the inflatable raft in water, the stabilization system comprising:
a dome coupled to the inflatable raft, the dome configured to prevent permanent capsizing of the inflatable raft; and
dome cover flaps configured to create a barrier between the interior of the dome and an outside environment.
an inflation system configured to automatically inflate the inflatable raft using a source of compressed gas after deployment from the aircraft;
one or more parachutes;
a guidance system configured to direct the apparatus after deployment from the aircraft;
a beacon configured to provide a location signal;
a battery configured to provide electrical power to one or more components of the life support package; and
a water propulsion system.
